(19) United States
(12) Patent Application Publication
(10) Pub. No.: US 2026/0036556 A1
(43) Pub. Date: Feb. 5, 2026

(54) ULTRASONIC TESTING DEVICE AND ULTRASONIC TESTING METHOD

(71) Applicant: Hitachi-GE Nuclear Energy, Ltd., Ibaraki (JP)

(72) Inventors: Riku NAKATA, Ibaraki (JP); Yuki OHSHIMA, Tokyo (JP); Yutaka ARAI, Ibaraki (JP); Yoshiaki NAGASHIMA, Ibaraki (JP)

(21) Appl. No.: 19/220,581

(22) Filed: May 28, 2025

(30) Foreign Application Priority Data
Jul. 31, 2024 (JP) 2024-124893

(51) Int. Cl. G01N 29/44; G01N 29/265; G21C 17/003; G21C 17/017

(52) U.S. Cl. CPC G01N 29/4454; G01N 29/265; G01N 2291/104; G21C 17/003; G21C 17/017

(57) ABSTRACT

An ultrasonic testing device uses a scanner, employing an ultrasonic probe for scanning, to ultrasonically test a desired tested range of a subject, and includes: an information acquirer to acquire data on the subject, the scanner, the ultrasonic probe, and testing conditions; an interference analyzer to use the data acquired by the information acquirer to calculate one or more interference ranges between the subject, having one or more interferers, and the scanner, having the ultrasonic probe attached thereto, and a scan path planner to use the one or more interference ranges to calculate a scan path of the ultrasonic probe, based on the acquired data on the testing conditions, so as to avoid the one or more interference ranges.

### CROSS-REFERENCE TO RELATED APPLICATION

This application claims the benefit of priority under 35 U.S.C. § 119 to Japanese Patent Application No. 2024-124893 filed on Jul. 31, 2024, the entire contents of which are incorporated herein by reference.

### TECHNICAL FIELD

The present invention relates to an ultrasonic testing device and an ultrasonic testing method for automatically planning a scan path of an ultrasonic probe, especially for use with a subject in a complicated shape and/or a subject having one or more interferers.

### BACKGROUND ART

Ultrasonic testing is employed to test a flaw in, or a thickness of, a subject such as a pipe and a vessel at a power plant. Ultrasonic testing includes a testing with manual scanning, in which a tester moves an ultrasonic probe along a surface of the subject, and a testing with automatic scanning, in which a scanning device moves its ultrasonic probe along a surface of the subject. Automatic scanning is preferably adopted in the case of a scan range on a surface of the subject being wide, from a viewpoint of testing efficiency.

Automatic scanning requires planning a scan path of an ultrasonic probe, in consideration of influence on a desired tested range from the shape of a surface of a subject and/or one or more interferers, and inputting data on the scan path into a controlling device. Accordingly, Japanese Patent Application Publication No. 2019-194533 A (hereinbelow, referred to as Patent Document 1) discloses a technique of determining a dead zone, where normal testing results are not expected, based on geometry of a surface of a steel stock measured by a measuring equipment, and storing the determined dead zone in a memory. Then, the dead zone is retrieved from the memory and an ultrasonic probe is controlled for testing flaws only in an area except the dead zone.

### SUMMARY OF THE INVENTION

### Problems to be Solved

However, in the case of the ultrasonic testing device of Patent Document 1, a non-testable range needs to be manually determined under multiple testing conditions, with the aid of CAD or the like. Accordingly, there has been a problem of requiring a heavy workload, especially when producing a testing plan and/or testing results on a subject in a complicated shape and/or a subject having one or more interferers.

The present invention has been devised in view of the above-described situation and is intended to provide an ultrasonic testing device and an ultrasonic testing method which are capable of planning effective testing on a subject in a complicated shape and/or a subject having one or more interferers.

### Solution to Problems

An ultrasonic testing device of the present invention to achieve the above-described objective uses a scanner, employing an ultrasonic probe for scanning, to ultrasonically test a desired tested range of a subject, and includes: an information acquirer to acquire data on the subject, the scanner, the ultrasonic probe, and testing conditions; an interference analyzer to use the data acquired by the information acquirer to calculate one or more interference ranges between the subject, having one or more interferers, and the scanner, having the ultrasonic probe attached thereto, and a scan path planner to use the one or more interference ranges to calculate a scan path of the ultrasonic probe, based on the acquired data on the testing conditions, so as to avoid the one or more interference ranges. Other aspects of the present invention are described below in embodiments.

### Advantageous Effects of the Invention

The present invention allows for planning effective testing on a subject in a complicated shape and/or a subject having one or more interferers.

### BRIEF DESCRIPTION OF THE DRAWINGS

FIG. 1 shows a configuration of an ultrasonic testing device according to a first embodiment of the present invention;

FIG. 2 illustrates a subject, a scanner, and an ultrasonic probe in the case where the scanner interferes with the subject while moving in a Y-axis direction;

FIG. 3 illustrates the subject, scanner, and ultrasonic probe when only the ultrasonic probe interferes with the subject;

FIG. 4A shows a tested range when a welded portion is tested;

FIG. 4B shows conditions of having ultrasonic waves incident on the subject with good transmittivity to ultrasonic waves;

FIG. 4C shows conditions of having ultrasonic waves incident on the subject with poor transmittivity to ultrasonic waves;

FIG. 5 illustrates steps to calculate a non-testable range when the subject has good transmittivity to ultrasonic waves;

FIG. 6 illustrates steps to calculate a non-testable range when the subject has good transmittivity to ultrasonic waves;

FIG. 7 illustrates steps to calculate a non-testable range when the subject has poor transmittivity to ultrasonic waves;

FIG. 8 illustrates steps to calculate a non-testable range when the subject has poor transmittivity to ultrasonic waves;

FIG. 9 is a flowchart of actions of a scanning planner according to the first embodiment;

FIG. 10 is a flowchart of actions of a scanning planner according to a second embodiment of the present invention;

FIG. 11A shows applicable portions of a nuclear plant; and

FIG. 11B schematically illustrates a scan path of the ultrasonic probe.

### DETAILED DESCRIPTION OF EMBODIMENTS

Hereinafter, embodiments of the present invention are described with reference to the drawings. Note that these are merely exemplary embodiments and are not intended to limit the present invention to particular aspects described below. The invention itself can be implemented in various aspects, as far as being in accordance with the claims.

### First Embodiment

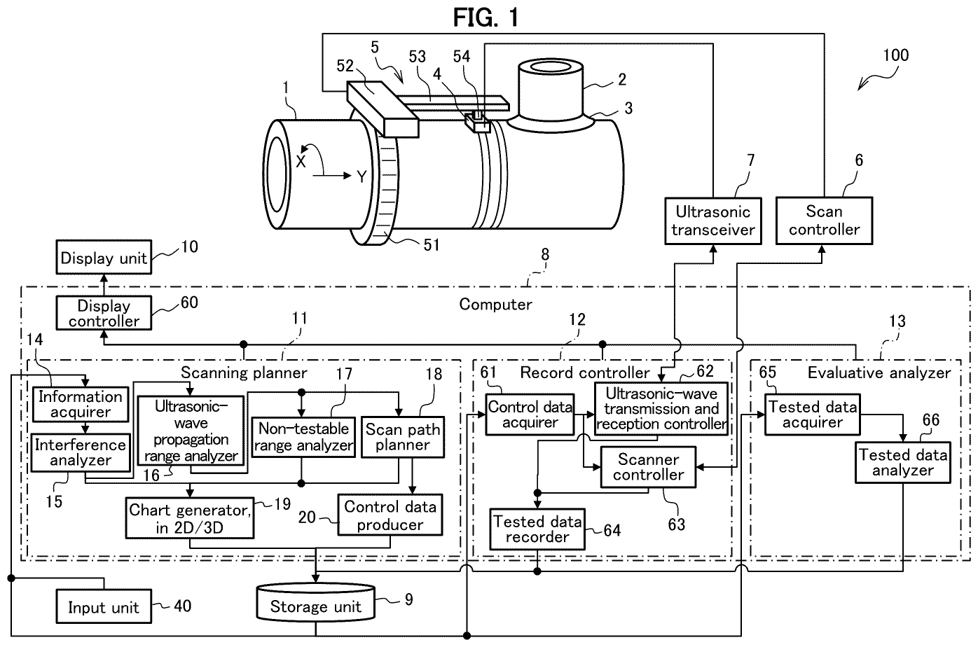

Hereinbelow, a first embodiment of the present invention is described with reference to FIGS. 1 to 8. FIG. 1 shows a configuration of an ultrasonic testing device 100 according to the first embodiment. A pipe as a subject 1 of the present embodiment has connections 2 and 3 to have other pipes connected thereto. The surface of the pipe is basically in a cylindrical shape but varies in shape in vicinity to the connections 2 and 3. The ultrasonic testing device of the present embodiment is used for testing pipes and the like.

The ultrasonic testing device 100 of the present embodiment includes an ultrasonic probe 4, a scanner 5 to use the ultrasonic probe 4 to scan a surface (outer surface) of the pipe along the surface, a scan controller 6 to control the scanner 5, and an ultrasonic transceiver 7 to transmit and receive ultrasonic waves through the ultrasonic probe 4.

In addition, the ultrasonic testing device 100 of the present embodiment includes a computer 8 connected via cable to the scan controller 6 and ultrasonic transceiver 7, a storage unit 9 connected via cable to the computer 8, a display unit 10 connected via cable to the computer 8, and an input unit 40 connected via cable to the computer 8. The computer 8 has one or more processors to execute processing according to one or more programs, one or more memories to store one or more programs and data, and the like. The storage unit 9 is configured with one or more hard disks and the like and stores geometric data of the pipe as the subject 1, and the like. The display unit 10 is configured with a display and the like. The input unit 40 is configured with a keyboard, a mouse, and the like.

The scanner 5 includes a first guiderail 51 attached to the pipe as the subject 1 and extending in a circumferential direction of the pipe, a first moving mechanism 52 (specifically configured with a motor or the like) to move a carriage along the first guiderail 51, a second guiderail 53 attached to the carriage and extending in an axial direction of the pipe, and a second moving mechanism 54 (specifically configured with a motor or the like) to move a probe support along the second guiderail 53. The probe support has, for example, a gimbal mechanism to support the ultrasonic probe 4 so as to be tilted in an axial direction and a circumferential direction of the pipe, and a pressing mechanism, such as a spring, to press the ultrasonic probe to the surface of the pipe. This causes a bottom surface (in other words, a surface to contact the pipe) of the ultrasonic probe 4 to follow the surface of the pipe.

The scan controller 6 has a control circuit to control the first moving mechanism 52 and second moving mechanism 54 in response to instructions from the computer 8, to control the position of the ultrasonic probe 4. As a particular example of moving sequence, the ultrasonic probe 4 may be moved from a start-of-moving point (X0, Y0) repeatedly by a pitch of ΔY in an axial direction (positive direction of a Y-axis) to reach a position (X0, Yn). Then, the probe may be moved by a pitch of ΔX in a circumferential direction (positive direction of an X-axis) to reach a position (X0+ΔX, Yn). Then, the probe may be moved repeatedly by the pitch of ΔY in the axial direction (now in a negative direction of the Y-axis) to reach a position (X0+ΔX, Y0). This cycle is repeated until the probe reaches an end-of-moving point (Xn, Yn).

The ultrasonic probe 4 is an angle probe comprising a piezoelectric element and a shoe (specifically, a probe to irradiate the surface of the pipe with ultrasonic waves at an angle to a line normal to the surface), for example.

The ultrasonic transceiver 7 has a pulser and a receiver, even though they are not shown. The pulser applies pulse signals to the piezoelectric element in response to an instruction from the computer 8 to cause the piezoelectric element to transmit ultrasonic waves via the shoe. If there is a defect inside the pipe, the piezoelectric element receives ultrasonic waves reflected by the defect, converts the waves into waveform signals, and outputs the signals. The receiver executes analog to digital conversion on the waveform signals inputted from the piezoelectric element to acquire waveform data, and outputs the data to the computer 8.

The computer 8 functionally includes a scanning planner 11, a record controller 12, and an evaluative analyzer 13. The scanning planner 11 of the computer 8 functionally includes an information acquirer 14, an interference analyzer 15, an ultrasonic-wave propagation range analyzer 16, a non-testable range analyzer 17, a scan path planner 18, a chart generator 19, and a control data producer 20. The computer 8 displays various data and analysis results on the display unit 10 via a display controller 60.

The information acquirer 14 has a function of acquiring geometric data of the subject having one or more interferers, geometric data and axial composition data of the scanner 5, and data on incident angles of ultrasonic waves and testing conditions, which are stored in the storage unit 9.

The interference analyzer 15 has a function of calculating an interference range between the subject, scanner 5, and ultrasonic probe 4, based on the acquired data. As a particular example of interference analysis, a tested range is defined on the subject, based on a welded point and a beveling shape, which are included in the acquired geometric data of the subject, and a tested range included in the data on the testing conditions. Based on an incident angle of the ultrasonic waves and a testing direction included in the data on the testing conditions, a scan range on the surface of the subject to be scanned by the ultrasonic probe 4 is calculated so that an ultrasonic-wave propagation range fully covers the defined tested range. With the ultrasonic probe 4 placed at points in the calculated scan range, positions and posture of the scanner at the points are calculated, and according to the calculation results, the presence or absence of interference with one or more interferers in the geometric data of the subject is calculated. A range determined to have interference is extracted as an interference range.

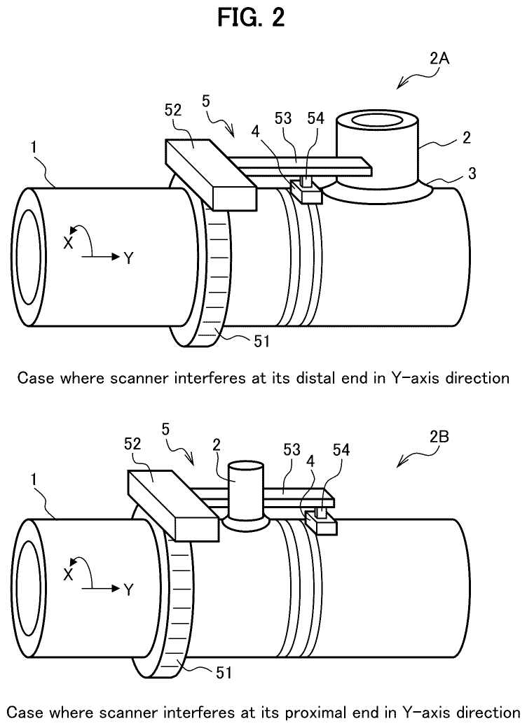

FIG. 2 illustrates the subject 1, scanner 5, and ultrasonic probe 4 when the scanner 5 interferes with the subject 1 while moving in a Y-axis direction. An interference case 2A is a case where the scanner 5 touches and interferes, at a distal end in a Y-axis direction of the second guiderail 53, with the connection 2. In this case, the first guiderail 51 cannot be moved right in the Y-axis direction in the drawing. An interference case 2B is a case where the scanner 5 touches and interferes, at a proximal end in the Y-axis direction of the second guiderail 53, with the connection 2. In this case, the first moving mechanism 52 cannot be moved around in an X-axis direction.

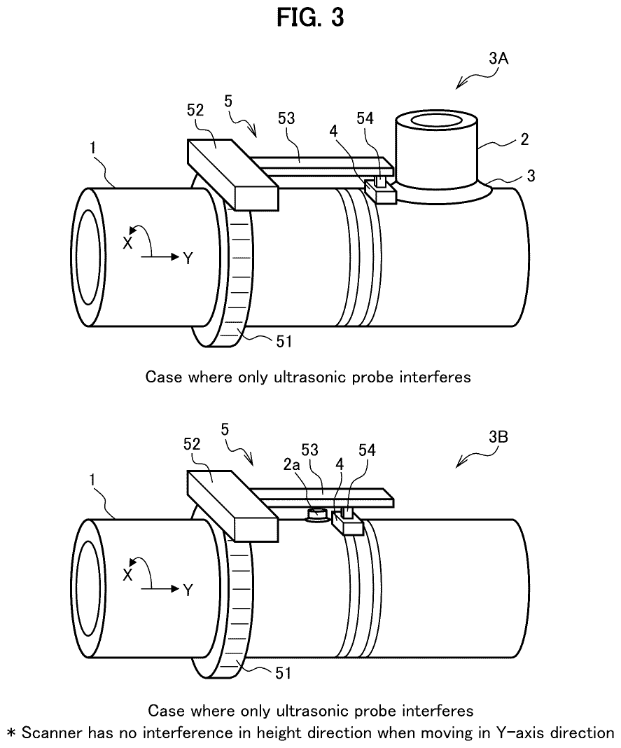

FIG. 3 illustrates the subject 1, scanner 5, and ultrasonic probe 4 when only the ultrasonic probe 4 interferes with the subject 1. An interference case 3A is a case where the ultrasonic probe 4 touches and interferes with the connection 3. In this case, the ultrasonic probe 4 cannot be moved right in the Y-axis direction in the drawing. An interference case 3B is a case where the ultrasonic probe 4 touches and interferes with a connection 2a. In this case, the ultrasonic probe 4 cannot be moved around in the X-axis direction.

Returning back to FIG. 1, the ultrasonic-wave propagation range analyzer 16 uses the interference range to calculate an ultrasonic-wave propagation range within the subject when the ultrasonic probe 4 scans a scan range other than the interference range.

The non-testable range analyzer 17 overlaps the ultrasonic-wave propagation ranges calculated under respective testing conditions, one on top of another, to distinguish between a range of a common ultrasonic-wave propagation range under multiple conditions, a range of an ultrasonic-wave propagation range only under a single condition, and a range outside of ultrasonic-wave propagation ranges. Further, one or more non-testable ranges are calculated based on a criterion of determining a non-testable range.

The scan path planner 18 calculates a scan path of the ultrasonic probe 4 so as to avoid the calculated interference range, based on the acquired data on testing condition. The chart generator 19 generates 2D or 3D charts of the calculated interference range, ultrasonic-wave propagation range, non-testable range, and scan path plan. The control data producer 20 produces input data for controlling the scanner, based on the calculated scan path plan.

The record controller 12 includes a control data acquirer 61 to acquire control data from the storage unit 9, an ultrasonic-wave transmission and reception controller 62 to transmit and receive signals to/from the ultrasonic transceiver 7, a scanner controller 63 to control the scan controller 6, and a tested data recorder 64 to record tested data from the ultrasonic-wave transmission and reception controller 62 and scanner controller 63 into the storage unit 9.

The evaluative analyzer 13 includes a tested data acquirer 65 to acquire tested data from the storage unit 9, and a tested data analyzer 66 to analyze the acquired tested data to determine whether or not the subject has any flaws.

### Testing Conditions

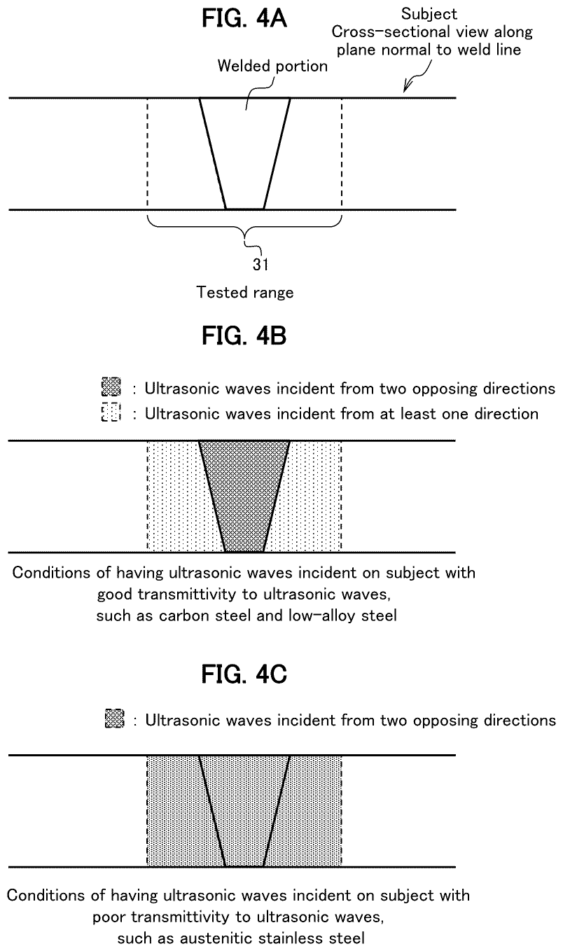

FIG. 4A shows a tested range when a welded portion is tested. FIG. 4B shows conditions of ultrasonic waves being incident on the subject with good transmittivity to ultrasonic waves. FIG. 4C shows conditions of ultrasonic waves being incident on the subject with poor transmittivity to ultrasonic waves.

With respect to a tested range 31 shown in FIG. 4A, ultrasonic waves need to be incident on the subject with good transmittivity to ultrasonic waves, such as carbon steel and low-alloy steel, from two opposing directions at the welded portion, while from at least one direction at a tested range surrounding the welded portion, as shown in FIG. 4B. In contrast, ultrasonic waves need to be incident on the subject with poor transmittivity to ultrasonic waves, such as austenitic stainless steel, from two opposing directions all over the tested range, inclusive of the welded portion and its surrounding area, as shown in FIG. 4C, in order to ensure effectiveness of ultrasonic testing.

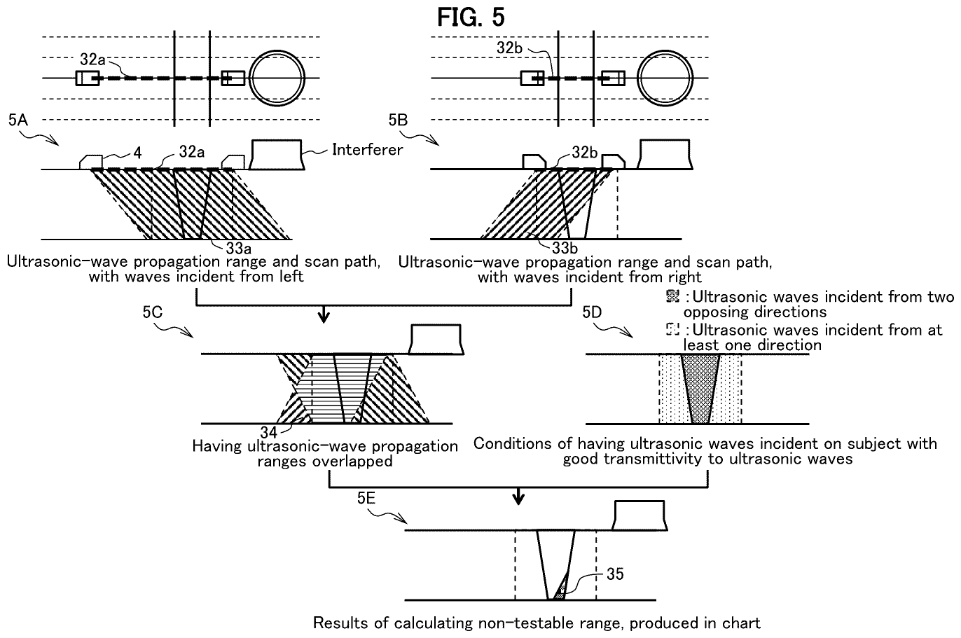

Note that the term “opposing” means to have the ultrasonic probe 4 positioned at two adjacent points on the surface of the pipe as the subject 1, which are spaced a predetermined distance apart in a longitudinal direction (right-left direction) of the pipe, so as to face each other, such as in FIGS. 1 and 5. The present embodiment is provided with the single ultrasonic probe 4, so that “opposing” means the probe after having been moved in the scan path is positioned at a right point so as to oppose the probe at a left point before being moved. Here, the scan path is set in the longitudinal direction of the pipe but may be set in a circumferential direction of the pipe. Further, the two ultrasonic probes 4 may be provided and configured to oppose each other.

Calculation of Non-Testable Range when Subject Having Good Transmittivity to Ultrasonic Waves

FIG. 5 illustrates steps to calculate a non-testable range when the subject has good transmittivity to ultrasonic waves (when points in vicinity to a center of the interferer are scanned). Scan cases 5A and 5B indicate scan paths to avoid the interferer and ultrasonic-wave propagation ranges when ultrasonic waves are incident on the welded portion obliquely from left and obliquely from right, respectively. An ultrasonic-wave propagation range 5C has the ultrasonic-wave propagation ranges overlapped one on the other to distinguish between a range having ultrasonic waves incident from the two opposing directions, a range having ultrasonic waves incident from only one of the two opposing directions, and a range having no ultrasonic waves incident. A condition 5D of ultrasonic waves being incident indicates the testing condition shown in FIG. 4B. A result 5E of calculating a non-testable range is acquired by applying the condition 5D to the ultrasonic-wave propagation range 5C and calculating a non-testable range determined to fail to satisfy the testing condition of the incidence condition 5D and thus not to be tested.

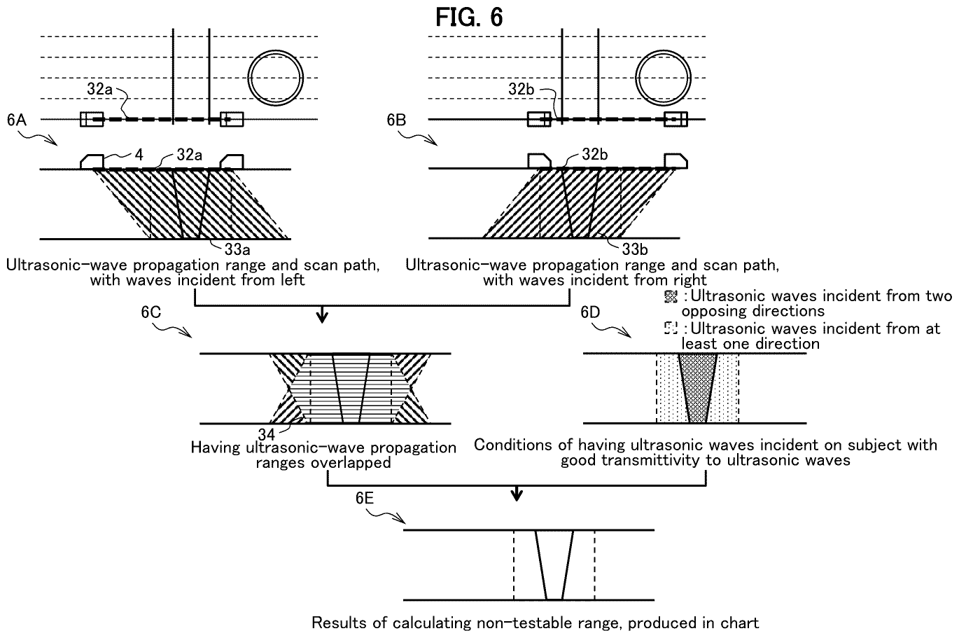

FIG. 6 illustrates steps to calculate a non-testable range when the subject has good transmittivity to ultrasonic waves (when points away from the interferer are scanned). Scan cases 6A and 6B indicate scan paths to avoid the interferer and ultrasonic-wave propagation ranges when ultrasonic waves are incident on the welded portion obliquely from left and obliquely from right, respectively. An ultrasonic-wave propagation range 6C has the ultrasonic-wave propagation ranges overlapped one on the other to distinguish between a range having ultrasonic waves incident from the two opposing directions, a range having ultrasonic waves incident from only one of the two opposing directions, and a range having no ultrasonic waves incident. A condition 6D of ultrasonic waves being incident indicates the testing condition shown in FIG. 4B. There is no interference and thus the scan path can fully cover the tested range, so that a result 6E of calculating a non-testable range has no non-testable ranges.

The non-testable range analyzer 17 uses calculated ultrasonic-wave propagation ranges (e.g., ultrasonic-wave propagation ranges 33a, 33b), when a desired tested range (e.g., a tested range 31 in FIG. 4A) is irradiated with ultrasonic waves from two opposing directions, for ultrasonic waves from the respective directions to calculate a dual ultrasonic-wave propagation range with the ultrasonic-wave propagation ranges from the two directions overlapping each other, and calculates a range in a specific tested range (e.g., the welded portion in FIG. 4A) in the desired tested range, other than the dual ultrasonic-wave propagation range, as a non-testable range (e.g., a non-testable range 35). Note that the term “from the respective directions” means “from one direction (e.g., from right) and “from the other direction (e.g., from left)” of the two opposing directions.

Calculation of Non-Testable Range when Subject Having Poor Transmittivity to Ultrasonic Waves

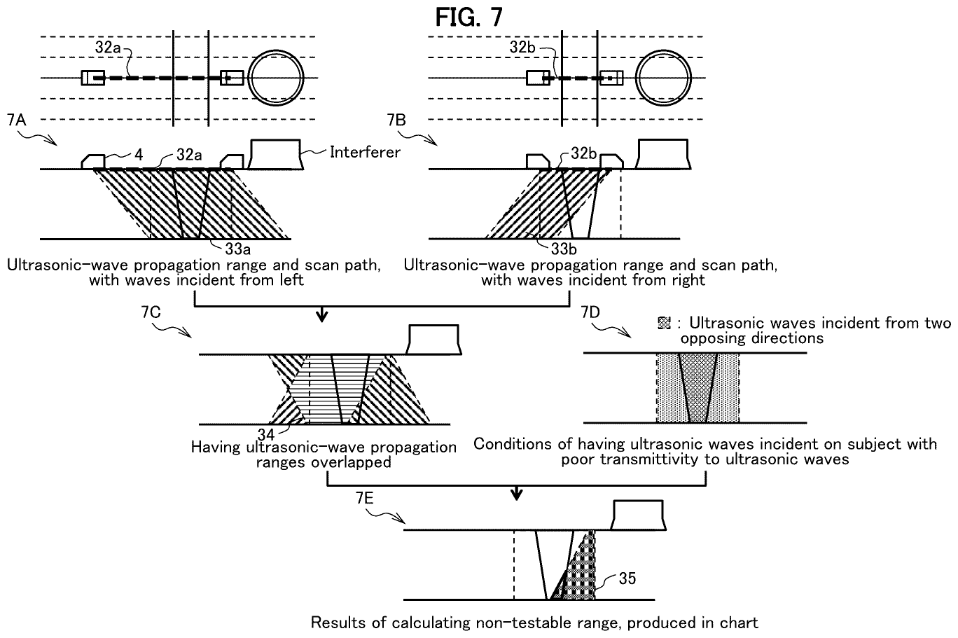

FIG. 7 illustrates steps to calculate a non-testable range when the subject has poor transmittivity to ultrasonic waves (when points in vicinity to a center of the interferer are scanned). It can be understood that a non-testable range in a result 7E of calculating a non-testable range is different from that in FIG. 5, even with the same interference range and scan path, due to a different condition 7D of ultrasonic waves being incident.

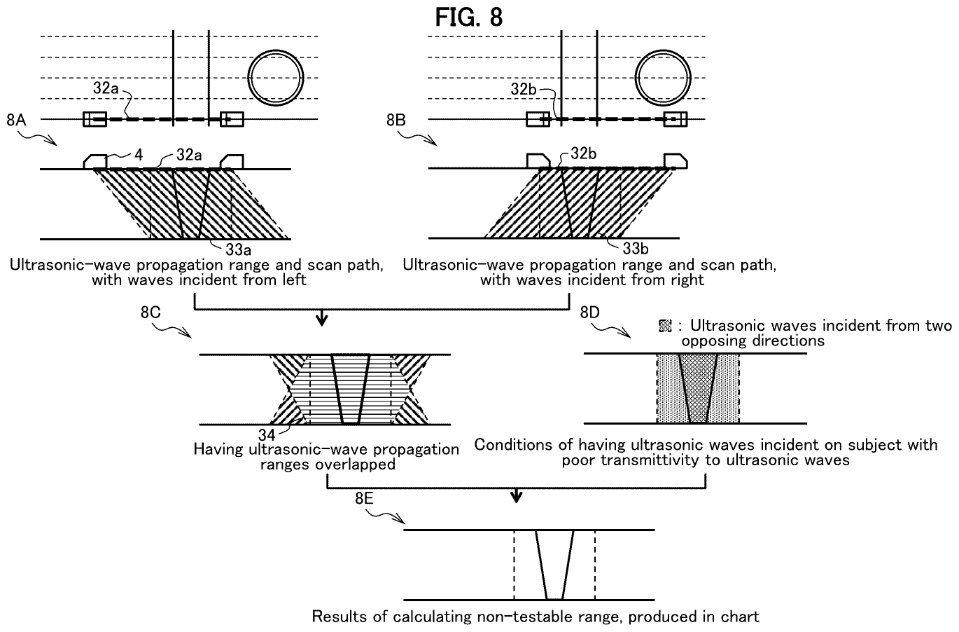

FIG. 8 illustrates steps to calculate a non-testable range when the subject has poor transmittivity to ultrasonic waves (when points away from the interferer are scanned). A condition 8D of ultrasonic waves being incident is different from that in FIG. 6, even with the same interference range and scan path. However, there is no interference and thus the scan path can fully cover the tested range, so that a result 8E of calculating a non-testable range is free from any non-testable range.

The non-testable range analyzer 17 uses calculated ultrasonic-wave propagation ranges (e.g., ultrasonic-wave propagation ranges 33a, 33b), when a desired tested range (e.g., a tested range 31 in FIG. 4A) is irradiated with ultrasonic waves from two opposing directions, for ultrasonic waves from the respective directions to calculate a dual ultrasonic-wave propagation range with the ultrasonic-wave propagation ranges from the two directions overlapping each other, and calculates a range in the desired tested range, other than the dual ultrasonic-wave propagation range, as a non-testable range (e.g., a non-testable range 35).

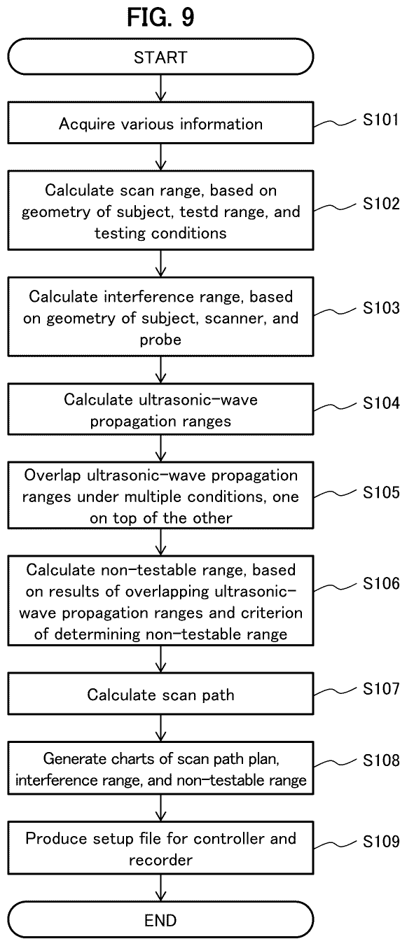

FIG. 9 is a flowchart of actions of the scanning planner 11 according to the first embodiment. In step S101, the information acquirer 14 acquires geometric data of the subject having one or more interferences, geometric data and axial composition data of the scanner 5, and data on incident angles of ultrasonic waves and testing conditions, which are stored in the storage unit 9.

In step S102, the interference analyzer 15 calculates a scan range to be scanned by the ultrasonic probe 4 to fully cover the tested range, based on the acquired data.

In step S103, the interference analyzer 15 calculates an interference range, in the calculated scan range, between the subject 1, scanner 5, and ultrasonic probe 4. As a particular example of interference analysis, the tested range 31 (see FIG. 4A) is first defined on the subject 1, based on a welded point and a beveling shape, which are included in the acquired geometric data of the subject, and a tested range included in the data on the testing conditions. Based on an incident angle of the ultrasonic waves and a testing direction included in the data on the testing conditions, a scan range 32a (see in FIG. 5 when having ultrasonic waves incident from left) and a scan range 32b (see in FIG. 5 when having ultrasonic waves incident from right) on the surface of the subject to be scanned by the ultrasonic probe 4 are calculated so that an ultrasonic-wave propagation range fully covers the defined tested range 31.

Further, the interference analyzer 15 calculates positions and posture of the scanner 5 at points in the calculated scan ranges 32a and 32b, with the ultrasonic probe 4 positioned at the points, and uses the calculation results to calculate presence or absence of interference with one or more interferers in the geometric data of the subject. A range calculated to have interference is extracted as an interference range. The relationship between the subject 1, scanner 5, and ultrasonic probe 4, when interference is calculated to exist, includes a case of the scanner 5 interfering with the subject while moving in the Y-axis direction or a case of only the ultrasonic probe 4 interfering with the subject, as shown in FIG. 3.

In step S104, the ultrasonic-wave propagation range analyzer 16 uses the interference range to calculate the ultrasonic-wave propagation ranges 33a (see in FIG. 5 when having ultrasonic waves incident from left) and 33b (see in FIG. 5 when having ultrasonic waves incident from right) within the subject when the ultrasonic probe 4 scans a scan range other than the interference range.

In step S105, the non-testable range analyzer 17 overlaps the ultrasonic-wave propagation ranges 33a and 33b (see FIG. 5) calculated under respective testing conditions, one on top of the other, to distinguish between an ultrasonic-wave propagation range 34 of a common ultrasonic-wave propagation range under multiple conditions, a range of an ultrasonic-wave propagation range only under a single condition, and a range outside of the ultrasonic-wave propagation ranges.

In step S106, the non-testable range analyzer 17 calculates a non-testable range 35, based on a criterion of determining a non-testable range.

In step S107, the scan path planner 18 calculates a scan path of the ultrasonic probe 4 so as to avoid the calculated interference range, based on the acquired data on testing conditions. The scan path is planned such that no scan path is produced in the interference cases 2A and 2B in FIG. 2, where the ultrasonic probe 4 cannot scan the interference range because the scanner 5 interferes with the subject, while a scan path is produced for partial testing in the interference cases 3A and 3B in FIG. 3, where only the ultrasonic probe 4 interferes with the subject, except a range where the ultrasonic probe 4 has interference.

In step S108, the chart generator 19 generates 2D or 3D charts of the calculated one or more interference ranges, ultrasonic-wave propagation ranges, non-testable ranges 35, and scan path plans.

In step S109, the control data producer 20 produces input data (setup file for controller and recorder) for controlling the scanner, based on the calculated scan path plan.

The first embodiment configured as described above has advantageous effects as follows. Automatic scanning of the scanner 5 moving the ultrasonic probe 4 along a surface of the subject 1 requires planning a scan path of the ultrasonic probe 4, in consideration of influence on a desired tested range from a shape of the surface of the subject and/or one or more interferers, and inputting data on the scan path into a controlling device. Accordingly, Patent Document 1 discloses the following technique. That is, a dead zone, where normal testing results are not expected, is determined based on geometry of a surface of a steel stock measured by a measuring equipment, and the determined dead zone is stored in a memory. Then, the dead zone is retrieved from the memory and the ultrasonic probe 4 is controlled for testing any flaws only in a region except the dead zone. However, in the case of the ultrasonic testing device of Patent Document 1, a non-testable range needs to be manually determined under multiple testing conditions, with the aid of CAD or the like. Accordingly, there has been a problem of requiring a heavy workload, especially when producing a testing plan and/or testing results on a subject in a complicated shape and/or a subject having one or more interferers.

For this problem, the ultrasonic testing device of the first embodiment uses the scanner 5, employing the ultrasonic probe 4 for scanning, to ultrasonically test a desired tested range of the subject 1, and includes: the information acquirer 14 to acquire data on the subject, the scanner, the ultrasonic probe, and testing conditions; the interference analyzer 15 to use the data acquired by the information acquirer 14 to calculate one or more interference ranges between the subject 1, having one or more interferers, and the scanner 5, having the ultrasonic probe 4 attached thereto; and the scan path planner 18 to use the one or more interference ranges to calculate a scan path of the ultrasonic probe 4, based on the acquired data on the testing conditions, so as to avoid the one or more interference ranges. This allows for automatically planning a scan path of the ultrasonic probe 4 to reduce a workload, especially for a subject in a complicated shape and/or a subject having one or more interferers, as compared with manually doing it with the aid of CAD or the like.

### Second Embodiment

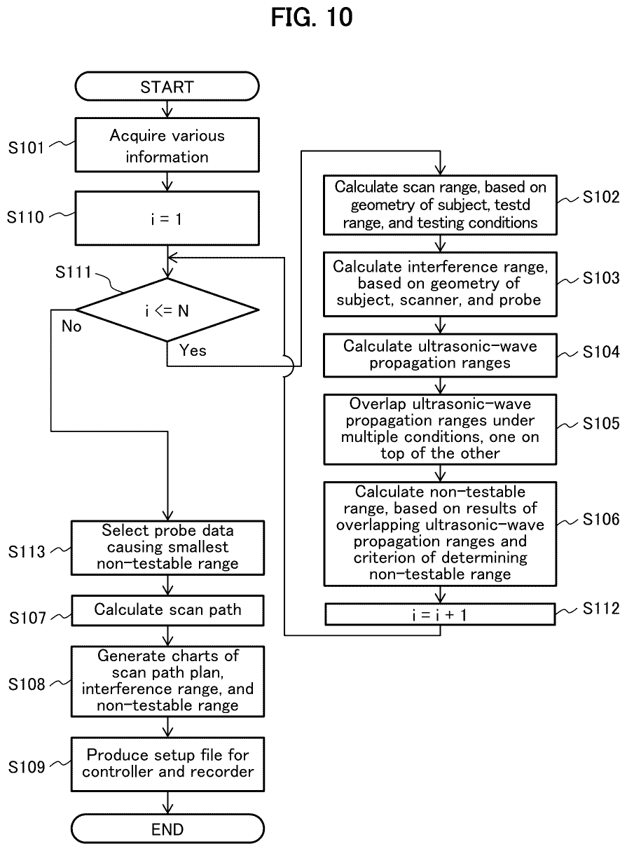

A second embodiment is described with reference to FIG. 10. FIG. 10 is a flowchart of actions of a scanning planner according to the second embodiment. Steps S101 to S109 are the same as those of the first embodiment, so that descriptions thereof are skipped.

The second embodiment repeats processing in steps S102 to S106 for probe data in an N number of cases, through the loop in steps S110 to S112, selects, in step S113, probe data causing the smallest non-testable range from those in the N number of cases, and uses the selected condition to execute processing in steps S107 to S109.

That is, a method of the second embodiment includes a selection step of calculating non-testable ranges for sets of data on the ultrasonic probe and then selecting a condition for the set of data on the ultrasonic probe causing the smallest non-testable range.

The second embodiment configured as described above has advantageous effects as follows. An ultrasonic testing method of the second embodiment uses the scanner 5, employing the ultrasonic probe 4 for scanning, to ultrasonically test a desired tested range of the subject, and the method calculates non-testable ranges under multiple testing conditions and then selects a testing condition causing the smallest non-testable range, so that the second embodiment allows for executing more reliable scanning by the ultrasonic probe 4.

### Example of Application

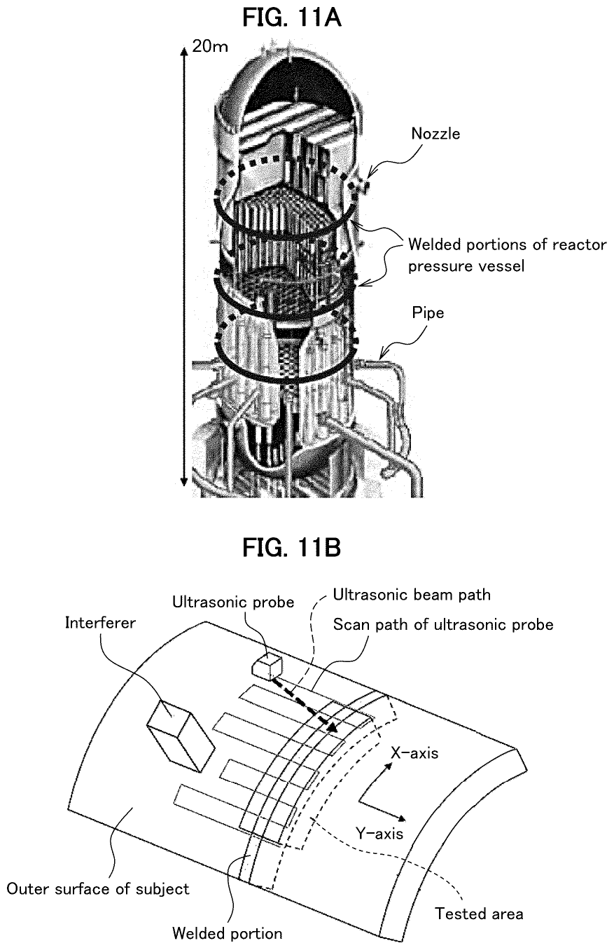

An example of applying the ultrasonic testing device 100 of the present embodiment is described next. FIG. 11A shows applicable portions of a nuclear plant. FIG. 11A shows an example of ultrasonic testing using the ultrasonic testing device 100 of the present embodiment for a reactor pressure vessel (RPV) and piping of a nuclear plant. Various weld lines and pipes of the RPV and a nozzle having the RPV connected thereto are subjected to testing.

FIG. 11B schematically illustrates a scan path of the ultrasonic probe 4. Rectangular scanning is executed in which the ultrasonic probe 4 scans an outer surface of the subject in two directions of a circumferential direction (X-axis direction) and an axial direction (Y-axis direction) so as to irradiate all the requested tested range in a through-thickness direction with ultrasonic waves. If there is/are one or more structures (interferers), such as an instrument nozzle, in vicinity to a weld line when a scan trajectory is planned, the plan (testing plan) to avoid the interferers is produced so as to prevent the scanner 5 including the ultrasonic probe 4 from interfering with the interferers.

Hereinabove, the ultrasonic testing device 100 of the present embodiment has been described, and an ultrasonic testing method has following features. 1) The ultrasonic testing method uses the scanner 5, employing the ultrasonic probe 4 for scanning, to ultrasonically test a desired tested range of the subject 1, and includes: an information acquiring step to acquire data on the subject, the scanner, the ultrasonic probe, and testing conditions; an interference analyzing step to use the data acquired in the information acquiring step to calculate one or more interference ranges between the subject 1, having one or more interferers, and the scanner 5, having the ultrasonic probe 4 attached thereto, and a scan path planning step to use the one or more interference ranges to calculate a scan path of the ultrasonic probe 4, based on the acquired data on the testing conditions, so as to avoid the one or more interference ranges. This allows for an effective testing plan for a subject in a complicated shape and/or a subject having one or more interferers.
2) The ultrasonic testing method of 1) includes an ultrasonic-wave propagation range analyzing step to use the interference range to calculate an ultrasonic-wave propagation range (e.g., ultrasonic-wave propagation ranges 33a, 33b in FIG. 5) within the subject when the ultrasonic probe 4 scans a scan range other than the interference range.
3) The ultrasonic testing method of 2) includes a non-testable range analyzing step to use calculated ultrasonic-wave propagation ranges, when a desired tested range (e.g., a tested range 31 in FIG. 4A) is irradiated with ultrasonic waves from two opposing directions, for ultrasonic waves from the respective directions to calculate a dual ultrasonic-wave propagation range with the ultrasonic-wave propagation ranges from the two directions overlapping each other, and calculates a range in a specific tested range (e.g., the welded portion in FIG. 4A) in the desired tested range, other than the dual ultrasonic-wave propagation range, as a non-testable range (e.g., a non-testable range 35 in FIG. 5) (see FIGS. 5 and 6).
4) The ultrasonic testing method of 2) includes a non-testable range analyzing step to use calculated ultrasonic-wave propagation ranges, when the desired tested range is irradiated with ultrasonic waves from two opposing directions, for ultrasonic waves from the respective directions to calculate a dual ultrasonic-wave propagation range with the ultrasonic-wave propagation ranges from the two directions overlapping each other, and calculates a range in the desired tested range, other than the dual ultrasonic-wave propagation range, as a non-testable range (see FIGS. 7 and 8).
5) The ultrasonic testing method of 3) or 4) includes a selection step of calculating non-testable ranges for sets of data on the ultrasonic probe and then selecting a condition for the set of data on the ultrasonic probe causing the smallest non-testable range.

### LEGEND FOR REFERENCE NUMERALS

1: subject, 2; 3: connection, 4: ultrasonic probe, 5: scanner, 6: scan controller, 7: ultrasonic transceiver, 8: computer, 9: storage unit, 10: display unit, 11: scanning planner, 12: record controller, 13: evaluative analyzer, 14: information acquirer, 15: interference analyzer, 16: ultrasonic-wave propagation range analyzer, 17: non-testable range analyzer, 18: scan path planner, 19: chart generator, 20: control data producer, 31: tested range, 32a: scan range (when having ultrasonic waves incident from left), 32b: scan range (when having ultrasonic waves incident from right), 33a: ultrasonic-wave propagation range (when having ultrasonic waves incident from left), 33b: ultrasonic-wave propagation range (when having ultrasonic waves incident from right), 34: ultrasonic-wave propagation range (common range between 32 and 33), 35: non-testable range, 40: input unit, 51: first guiderail, 52: first moving mechanism, 53: second guiderail, 54: second moving mechanism, 60: display controller, 61: control data acquirer, 62: ultrasonic-wave transmission and reception controller, 63: scanner controller, 64: tested data recorder, 65: tested data acquirer, 66: tested data analyzer, and 100: ultrasonic testing device.

What is claimed is:

1. An ultrasonic testing device using a scanner, employing an ultrasonic probe for scanning, to ultrasonically test a desired tested range of a subject, the device comprising:
an information acquirer to acquire data on the subject, the scanner, the ultrasonic probe, and testing conditions;
an interference analyzer to use the data acquired by the information acquirer to calculate one or more interference ranges between the subject, having one or more interferers, and the scanner, having the ultrasonic probe attached thereto, and
a scan path planner to use the one or more interference ranges to calculate a scan path of the ultrasonic probe, based on the acquired data on the testing conditions, so as to avoid the one or more interference ranges.

2. The ultrasonic testing device according to claim 1 further comprising:
an ultrasonic-wave propagation range analyzer to use the interference range to calculate an ultrasonic-wave propagation range within the subject when the ultrasonic probe scans a scan range other than the interference range.

3. The ultrasonic testing device according to claim 2 further comprising:
a non-testable range analyzer to use calculated ultrasonic-wave propagation ranges, when the desired tested range is irradiated with ultrasonic waves from two opposing directions, for ultrasonic waves from the respective directions to calculate a dual ultrasonic-wave propagation range with the ultrasonic-wave propagation ranges from the two directions overlapping each other, and calculates a range in a specific tested range in the desired tested range, other than the dual ultrasonic-wave propagation range, as a non-testable range.

4. The ultrasonic testing device according to claim 2 further comprising:
a non-testable range analyzer to use calculated ultrasonic-wave propagation ranges, when the desired tested range is irradiated with ultrasonic waves from two opposing directions, for ultrasonic waves from the respective directions to calculate a dual ultrasonic-wave propagation range with the ultrasonic-wave propagation ranges from the two directions overlapping each other, and calculates a range in the desired tested range, other than the dual ultrasonic-wave propagation range, as a non-testable range.

5. An ultrasonic testing method using a scanner, employing an ultrasonic probe for scanning, to ultrasonically test a desired tested range of a subject, the method comprising:
an information acquiring step of acquiring data on the subject, the scanner, the ultrasonic probe, and testing conditions;
an interference analyzing step of using the data acquired in the information acquiring step to calculate one or more interference ranges between the subject, having one or more interferers, and the scanner, having the ultrasonic probe attached thereto, and
a scan path planning step of using the one or more interference ranges to calculate a scan path of the ultrasonic probe, based on the acquired data on the testing conditions, so as to avoid the one or more interference ranges.

6. The ultrasonic testing method according to claim 5, further comprising:
an ultrasonic-wave propagation range analyzing step of using the interference range to calculate an ultrasonic-wave propagation range within the subject when the ultrasonic probe scans a scan range other than the interference range.

7. The ultrasonic testing method according to claim 6, further comprising:
a non-testable range analyzing step of using calculated ultrasonic-wave propagation ranges, when the desired tested range is irradiated with ultrasonic waves from two opposing directions, for ultrasonic waves from the respective directions to calculate a dual ultrasonic-wave propagation range with the ultrasonic-wave propagation ranges from the two directions overlapping each other, and calculating a range in a specific tested range in the desired tested range, other than the dual ultrasonic-wave propagation range, as a non-testable range.

8. The ultrasonic testing method according to claim 6, further comprising:
a non-testable range analyzing step of using calculated ultrasonic-wave propagation ranges, when the desired tested range is irradiated with ultrasonic waves from two opposing directions, for ultrasonic waves from the respective directions to calculate a dual ultrasonic-wave propagation range with the ultrasonic-wave propagation ranges from the two directions overlapping each other, and calculating a range in the desired tested range, other than the dual ultrasonic-wave propagation range, as a non-testable range.

9. The ultrasonic testing method according to claim 7, further comprising:
a selection step of calculating non-testable ranges for sets of data on the ultrasonic probe and then selecting a condition for the set of data on the ultrasonic probe causing the smallest non-testable range.

10. The ultrasonic testing method according to claim 8, further comprising:
a selection step of calculating non-testable ranges for sets of data on the ultrasonic probe and then selecting a condition for the set of data on the ultrasonic probe causing the smallest non-testable range.
